(19) United States
(12) Patent Application Publication
(10) Pub. No.: US 2012/0182891 A1
(43) Pub. Date: Jul. 19, 2012

(54) PACKET ANALYSIS SYSTEM AND METHOD USING HADOOP BASED PARALLEL COMPUTATION

(76) Inventors: Youngseok Lee, Daejeon (KR); Yeonhee Lee, Daejeon (KR)

(21) Appl. No.: 13/090,670

(22) Filed: Apr. 20, 2011

(30) Foreign Application Priority Data
Jan. 19, 2011 (KR) 10-2011-0005424
Jan. 21, 2011 (KR) 10-2011-0006180
Jan. 24, 2011 (KR) 10-2011-0006691

(51) Int. Cl. H04L 12/26

(52) U.S. Cl. 370/252

(57) ABSTRACT

The present invention relates to a packet analysis system and method, which enables cluster nodes to process in parallel a large quantity of packets collected in a network in an open source distribution system called Hadoop. The packet analysis system based on a Hadoop framework includes a first module for distributing and storing packet traces in a distributed file system, a second module for distributing and processing the packet traces stored in the distributed file system in a cluster of nodes executing Hadoop using a MapReduce method, and a third module for transferring the packet traces, stored in the distributed file system, to the second module so that the packet traces can be processed using the MapReduce method and outputting a result of analysis, calculated by the second module using the MapReduce method, to the distributed file system.

### CROSS-REFERENCES TO RELATED APPLICATION

This application claims under 35 U.S.C. §119(a) the benefit of Korean Patent Applications No. 10-2011-0005424, No. 10-2011-0006180 and 10-2011-0006691 filed on Jan. 19, 2011, Jan. 21, 2011 and Jan. 24, 2011, respectively, the entire disclosure of which is incorporated by reference herein.

### BACKGROUND OF THE INVENTION

1. Technical Field

The present invention relates to a packet analysis system and method in an open source distribution system hereinafter called Hadoop, wherein cluster nodes can process a large quantity of packets, collected from a network, in parallel.

2. Related Art

A job for measuring and analyzing network traffic, indicating the degree of quantity of data transmitted over a network, is one of the basic and most important fields in researching within the field of computer networks. Network traffic measurements are indispensable to checking the operating state of a network, checking traffic characteristics, designing and planning, blocking of harmful traffic, billing, and guaranteeing of Quality of Service (QoS).

Typically, network traffic analysis includes an analysis method according to the number of packets and an analysis method according to the number of flows. Early traffic analysis was chiefly performed according to the number of packets in the network, but an analysis method according to the number of flows (that is, a set of packets) has begun to be widely used because of the recent rapid increase in the number of Internet users and in the volume of networks and traffic associated with those users. In the flow-based analysis method, packets having common characteristics (for example, a source IP address, a destination IP address, a source port, a destination port, a protocol ID, and a DSCP) are bundled into a unit called a flow and analyzed, instead of measuring and analyzing each individual packet. The flow-based analysis method typically reduces the delay time that it takes to perform traffic analysis and processing because traffic is analyzed based on a flow of packets which are bundled based on certain like criteria. This method, however, is disadvantageous in that it has a lesser quantity of provided data as compared with packet analysis because a flow includes insufficient detailed information about packets.

The measurement and analysis of Internet traffic collected in large quantities requires a high capacity of storage space and high processing performance. In particular, the measurement and analysis of traffic in units of packets requires greater storage space and processing ability than the measurement and analysis of traffic in units of flow. However, collection and analysis tools now being executed in a single node have a limit in satisfying these requirements. For this reason, a traffic analysis method using Cisco NetFlow has been proposed, where a router collects pieces of flow information passing through each network interface and provides the collected flow information. An analysis method in the unit of a flow includes IPFIX, and Flow-Tool is used as a representative analysis tool. The analysis tool in units of flow, such as IPFIX, is typically expected to have higher performance than the packet analysis method because it is operated on a single server. However, the flow analysis tool is problematic in that the speed of traffic analysis may be lowered because the performance of a flow analysis server functions as overhead. The above problem becomes even worse in a system for collecting a large quantity of packet related data from routers for processing a large quantity of traffic in a high-speed Internet network ranging from several hundreds of Mbps to several tens of Gbps and for processing the collected packet data. Accordingly, there is a need for a high-performance server for rapidly analyzing flow data and transferring a result of the analysis to a user in order to measure the traffic in a network accurately, which can be a burden in terms of costs.

Hadoop was originally developed to support distribution for the Nutch search engine project and is a data processing platform that provides a base for fabricating and operating applications capable of processing several hundreds of gigabytes to terabytes or petabytes. Since the size of data processed by Hadoop is typically a minimum of several hundreds of gigabytes, the data is not stored in one computer, but split into several blocks and distributed into and stored in several computers. To this end, Hadoop includes a Hadoop Distributed File System (hereinafter referred to as an ‘RDFS’) and a process for distributing and processing input data. The distributed and stored data is processed by a process known hereinafter as “MapReduce” developed to process a large quantity of data in parallel in a cluster environment. Hadoop is being widely used in various fields in which a large quantity of data needs to be processed, but a packet analysis system and method using Hadoop has not yet been developed.

FIG. 1 is a conceptual diagram showing the flow of data when a job is processed in a Hadoop MapReduce program consisting of a Mapper and a Reducer. An input file stores data to be performed by the MapReduce program, and is typically stored in the HDFS. Hadoop supports various data formats as well as the text data format.

When a job is started at the request of a client, an input format IF determines how the input file will be split and read. That is, the input format created InputSplits by splitting the input file for the data of a corresponding block and, at the same time, creates and returns RecordReaders RR each for separating a record of a (Key, Value) form from the InputSplit and for transferring the records to the Mapper. The InputSplit is the unit of data processed by a single Map task in the MapReduce program. Hadoop provides various input formats and output formats for processing text data according to characteristic of web crawling and includes input formats, such as TextInputFormat, KeyValueInputFormat, and SequenceInputFormat. TextInputFormat is a representative input format. TextInputFormat constructs InputSplits (that is, a logical input unit) by splitting an input file, stored in unit of block, on the basis of each line and returns LineRecordReader for extracting records of a (LongWritable, Text) form from the InputSplits.

The returned RecordReader functions to read the records each consisting of a pair made up of a key and a value from the InputSplit and to transfer the records to the Mapper during the typical Map process. The Mapper generates records each having a new key and value by performing the Map function defined in the Mapper. An output format OutputFormat (OF) is a format for outputting data, generated in the MapReduce process, to the HDFS. The output format terminates the data processing process by storing the records (each consisting of the key and value), received as a result of the MapReduce process, in the HDFS through a RecordWriter RW (that is, a subclass).

SequenceInputFormat provides inputs and outputs for data formats other than the text data format. The sequence input format supports inputs and outputs for compression files, such as deflate, gzip, ZIP, bzip2, and LZO. The compression file format is advantageous in that they can improve storage space efficiency. However, the compression file format is disadvantageous in that the processing speed is low because in order to process an input file according to the compression file format, performing decompression before the MapReduce process is started and thus compression of processed results again is required. The SequenceInputFormat provides a frame capable of containing data of various formats including the binary format, but requires an additional conversion process of converting source data to be contained in a form of a series of sequences.

For this reason, in order to process a large quantity of data having the binary format, such as images and communication packets, in Hadoop distribution environments, the conversion of data into the text format or the conversion of data into other formats capable of being recognized in Hadoop is required. The above described conversion includes a process of a single system reading a file to be converted, converting the read file, and storing the converted file. However, the process is counter productive to the fundamental aims of improving the processing performance using the Hadoop distribution system. Accordingly, there is a need for the development of a more effective method for processing binary data in a Hadoop distribution environment.

### SUMMARY OF THE DISCLOSURE

Accordingly, the present invention has been made in view of the above problems occurring in the prior art, and it is an object of the present invention to provide a system and method in which a large quantity of packet data can be distributed into and stored in a plurality of servers by using a Hadoop distributed system (that is, a framework capable of processing large quantity of packet data) and the plurality of servers can analyze the packet data through parallel computation.

It is another object of the present invention to provide an input format to each of binary data, having a data record block of a fixed length, and each of binary data, having a data record block of a variable length, in order to improve Hadoop based packet data processing.

To achieve the above objects, the present invention provides a packet analysis system based on a Hadoop framework, including a packet collection module for collecting and storing packet traces in a Hadoop Distributed File System (HDFS), a packet analysis module for distributing and processing the packet traces stored in the HDFS in the cluster nodes of Hadoop using a MapReduce method, and a Hadoop input/output format module for transferring the packet traces, stored in the HDFS, to the packet analysis module so that the packet traces can be processed using the MapReduce method and for outputting an analysis result, calculated by the packet analysis module using the MapReduce method, to the HDFS.

Furthermore, the present invention provides a packet analysis method using Hadoop-based parallel computation, including the steps of (A) storing packet traces in the HDFS, (B) a cluster of nodes of Hadoop reading the packet traces stored in the HDFS, extracting records from the packet traces, and transferring the records to a MapReduce program, (C) analyzing the transferred records using the MapReduce method, and (D) storing the analyzed records in the HDFS.

### BRIEF DESCRIPTION OF THE DRAWINGS

Further objects and advantages of the invention can be more fully understood from the following detailed description taken in conjunction with the accompanying drawings in which:

FIG. 1 is a conceptual diagram showing the flow of data when a job is processed in a Hadoop MapReduce program consisting of a Mapper and a Reducer;

FIG. 2 is a block diagram showing a packet analysis system according to the present invention and its internal construction;

FIG. 3 is a block diagram showing the internal construction of a packet collection module;

FIG. 4 is a flowchart illustrating a procedure of the cluster nodes reading data blocks and processing the read data blocks using the pcap input format, in order to read a high capacity of a packet trace data container and analyze packets using a Hadoop MapReduce method;

FIG. 5 is a flowchart illustrating a method of finding the start byte of a first packet at step 201 of FIG. 4 according to an exemplary embodiment of the present invention;

FIG. 6 is a flowchart illustrating a procedure in which the cluster nodes of a Hadoop read and process data blocks according to a binary input format;

FIG. 7 is a diagram showing a packet analysis process according to an exemplary embodiment of the present invention;

FIG. 8 is a diagram showing a packet analysis algorithm according to another exemplary embodiment of the present invention;

FIG. 9 is a diagram showing an algorithm for finding statistics of flows generated from the packets of FIG. 7; and

FIG. 10 is a diagram showing a packet analysis algorithm according to another exemplary embodiment of the present invention.

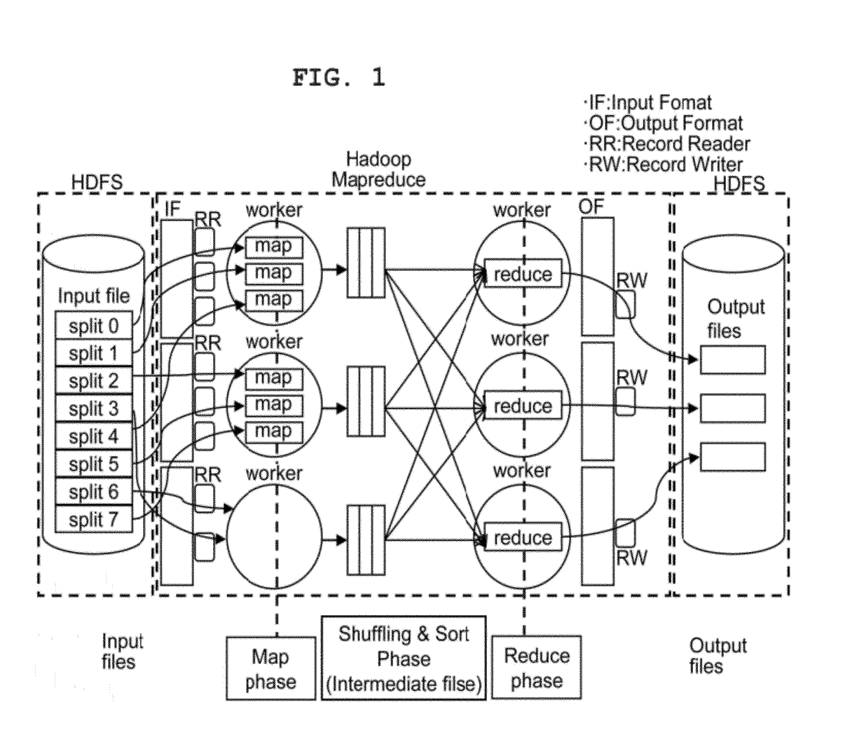

### DETAILED DESCRIPTION OF EMBODIMENTS

Some exemplary embodiments of the present invention will now be described in detail with reference to the accompanying drawings. It is however to be understood that the drawings are only examples for easily describing the contents and scope of the technical spirit of the present invention and the technical scope of the present invention is not restricted or changed by the drawings. Furthermore, it will be evident to those skilled in the art that various modifications and changes are possible within the scope of the technical spirit of the present invention based on the above examples.

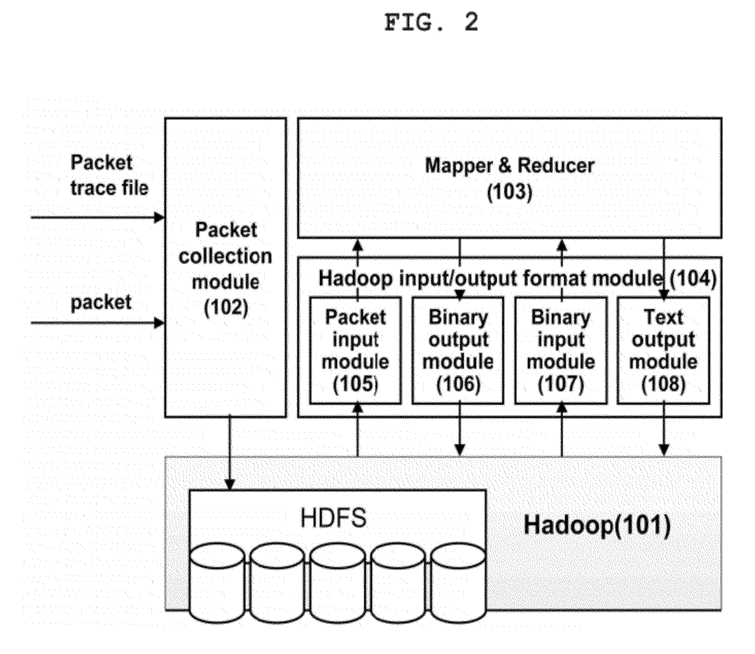

The present invention relates to a system in which a cluster of nodes are implemented to process a large quantity of packets in parallel in an open source distribution system called Hadoop. FIG. 2 is a block diagram showing a packet analysis system according to the present invention and the internal construction of the system. Referring to FIG. 2, the packet analysis system of the present invention is based on a Hadoop framework 101. The packet analysis system includes a first module (packet collection module) 102, a second module (Mapper & Reducer) 103, and a third module (Hadoop input/output format module) 104. The packet collection module 102 distributes and stores packet traces into and in an HDFS. The Mapper & Reducer 103 distributes and processes a large quantity of the packet traces, stored in the HDFS, in the cluster of nodes of Hadoop 101 using a MapReduce method. The Hadoop input/output format module 104 transfers a large quantity of the packet traces of the HDFS to the Mapper & Reducer 103 so that the packet traces can be processed according to the MapReduce method and outputs results, analyzed by the Mapper & Reducer 103 using a MapReduce program composed of a Mapper and a Reducer, to the HDFS. The packet traces may have been generated in the form of a packet trace data container (e.g., a file) or may be generated by capturing the packet traces from packets collected in real time over a network.

FIG. 2 shows a block diagram of a pcap input format module 105, a binary output format module 106, a binary input format module 107, and a text output format module 108 which are the detailed elements of the Hadoop input/output format module 104. It is, however, to be noted that the above elements are only examples of the Hadoop input/output format module 104. In the present invention, the Hadoop input/output format module 104 is not limited to the above elements, but may include other elements properly selected according to analysis purposes, from among the existing elements for the Hadoop input/output format or elements for an input/output format to be subsequently designed for processing using the Hadoop MapReduce method.

For example, the text output format is the existing output format, but the pcap input format may be used with the present invention for the Hadoop MapReduce method of binary packet data having records of a variable length. Also, the binary input/output format, on the other hand, provides more efficient analysis into binary data having records of a fixed length. The binary input/output format and the pcap input format will be described in more detail below in relation to a packet analysis method. In accordance with the binary input/output format or the pcap input format, packet data can be processed more efficiently because the binary data is processed using the Hadoop MapReduce method without an existing conversion into additional data formats. However, the system of the present invention can be implemented using only the known input/output format, such as a sequence input/output format or a text input/output format.

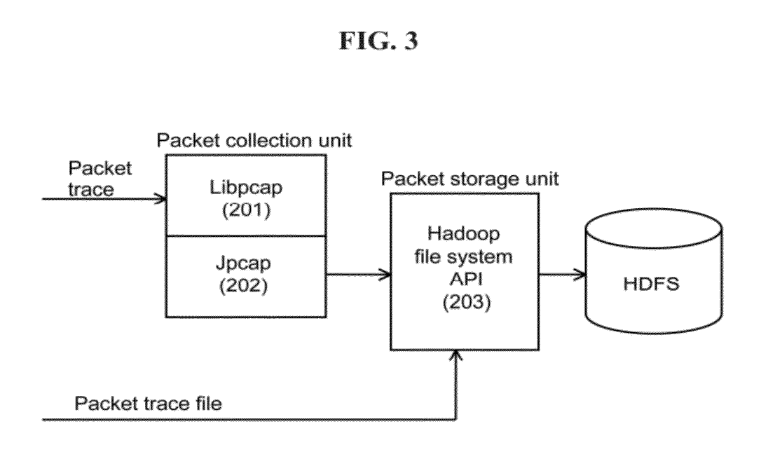

FIG. 3 is a block diagram showing the internal construction of the packet collection module of the distributed parallel packet analysis system according to the present invention. The packet collection module includes a packet collection unit for collecting packet traces from packets over a network and a packet storage unit for enabling the packet traces, collected by the packet collection unit, or a previously generated packet trace file to be stored in the HDFS using a Hadoop file system API 203. The detailed elements of the packet collection module are described below. First, packets over a network are collected using Libpcap 201. Jpcap 202 (that is, a java-based capture tool) transfers the collected packets to Hadoop for a cooperative operation with, e.g., a java-based Hadoop system. The Hadoop file system API 203 stores the transferred packet traces in the HDFS.

The packet collection module collects packets moving over a network in real time and stores the packet traces of the packets in the HDFS. Furthermore, a file previously stored in the form of the packet trace file is stored in the HDFS through the Hadoop file system API.

Furthermore, the present invention relates to a packet analysis method using the above system. More particularly, the packet analysis method according to the present invention includes the steps of (A) storing packet traces in the HDFS, (B) a cluster of nodes of Hadoop 101 reading the packet traces stored in the HDFS, extracting records from the packet traces, and transferring the records to the Mapper of MapReduce; (C) analyzing the transferred records using a MapReduce method; and (D) storing the analyzed records in the HDFS.

The packet traces at step (A) may have been previously generated in the form of a packet trace file or may be generated by capturing the packet traces from packets collected in real time over a network.

To read the packet traces stored in the HDFS at step (B), a function is performed through the input format of Hadoop, which creates a logical processing unit hereinafter referred to as “InputSplit” for MapReduce and passes RecordReader to Map task for parsing records from the InputSplit. The input format may be one of various input formats provided in the existing Hadoop system or may be implemented using an additional packet input format. The input format defines a method of reading the records from the data block stored in the HDFS. Packets can be analyzed more effectively by using an appropriate input format.

For this purpose, the input format is used to analyze binary packet data including records of a variable length. The input format performs the steps of (a) obtaining information about the start time and the end time when the packets are captured in such a way as to transfer common data using a MapReduce program, such as configuration property or DistributedCache; (b) searching for the start point of a first packet in a data block to be processed, from among the data blocks stored in the HDFS; (c) defining an InputSplit by setting the boundary of a previous InputSplit and its own InputSplit by using the start point of the first packet as the start point of the corresponding InputSplit; (d) generating a RecordReader for performing a process for reading the entire area of the defined InputSplit from the start point by a capture length CapLen recorded on the captured pcap header of each packet and for returning the generated RecordReader; and (e) extracting the records, each having a key and a value in a (LongWritable, BytesWritable) form, using the generated RecordReader. The input format is also called the pcap input format.

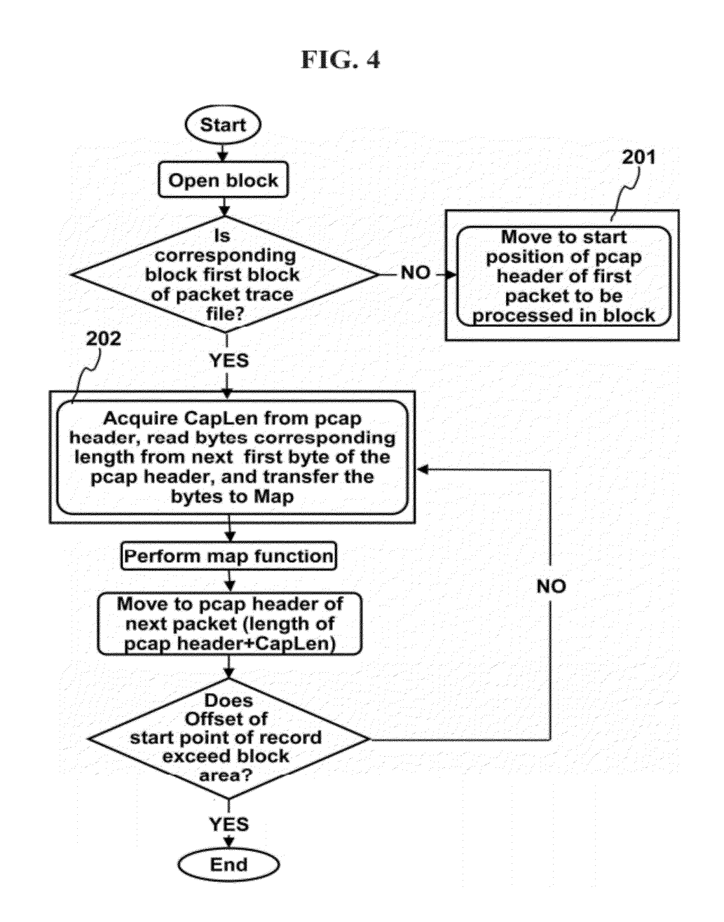

FIG. 4 is a flowchart illustrating a procedure of the cluster of nodes for reading data blocks and processing the read data blocks using the pcap input format, in order to read a high capacity of packet trace files and to analyze packets using the Hadoop MapReduce method. In FIG. 4 it is assumed that information about the start time and the end time when the packets are captured before a job is executed has been previously obtained through the configuration property.

When a data block is opened for data processing, it is determined whether the start point of the data block is the start point of a packet. If, as a result of the determination, the start point of the data block is determined to be the first block of a packet trace file, the start point of the data block will become the start point of the packet, and thus the start point is defined as the start point of the InputSplit. If, as a result of the determination, the start point of the data block is determined to not be the first block of the packet trace file, the start point of the data block is not identical to the start point of the packet, and thus a process 201 of finding the start point for real packet processing is performed.

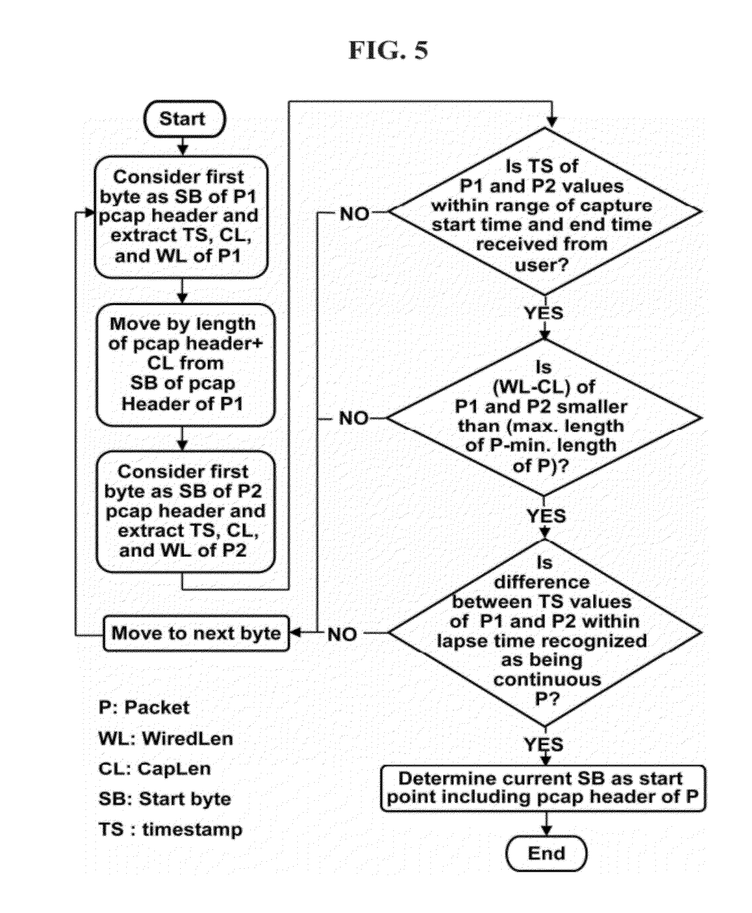

FIG. 5 shows an exemplary embodiment for finding the start point of a first packet in the data block. It is first assumed that the start byte of a block is the start point of the first packet. (i) First, Header information, including a timestamp, a capture length CapLen, and a wired length WiredLen, is extracted from the pcap header of the first packet at the point assumed to be the start point of the first packet. The timestamp, the capture length, and the wired length are hereinafter referred to as TS1, CapLen1, and WiredLen1, respectively. Here, the timestamp is recorded on the first, e.g., 8 bytes of the pcap header, the capture length is recorded on the next, e.g., 4 bytes of the pcap header, and the wired length is recorded on, e.g., the next 4 bytes of the pcap header. Accordingly, the header information can be extracted by reading, in this example, the 16 bytes from the start byte of the block. Here, the timestamp may use only the first 4 bytes because timestamp information per second can be obtained even though only the first 4 bytes are used. If it is sought to further increase accuracy, 8 bytes may be used instead of the 4 bytes.

(ii) Second, after data for the first packet is extracted, header information about a second packet, including a timestamp, a capture length, and a wired length, is extracted from a point assumed to be the start point of the second packet using the same method as described above. The timestamp, the capture length, and the wired length are hereinafter referred to as TS2, CapLen2, and WiredLen2, respectively. The start point of the second packet will become a point that has moved by as much as a value in which the length (typically 16 bytes) of the pcap header of the first packet and the capture length recorded on the pcap header are added. Next, the system verifies whether the first bytes of the data block is identical to the start point of the first packet based on the pieces of header information about the first packet and the second packet obtained in (i) and (ii).

A method of verifying the start point of a packet is described below with reference to FIG. 5. In this method the system (a) checks whether each of TS1 and TS2 are a valid value from the capture start time of the packet, obtained from the configuration property, to the end time of the packet. The system additionally (13) checks whether a difference between WiredLen1 and CapLen1 is smaller than a difference between a maximum length of the packet and a minimum length of the packet. Likewise, a difference between WiredLen2 and CapLen2 is also checked. It is assumed that the maximum length and the minimum length of the packet are, e.g., 1,518 bytes and 64 bytes, respectively, according to the definition of the Ethernet frame. (γ) It is verified whether the packets have been introduced according to a continuation of TS1 and TS2. To this end, a delta time in which packets are recognized to be continuous is determined by finding the difference between TS1 and TS2. It is then determined whether the delta time corresponds to the range of the difference. The delta time preferably is within 5 seconds, but may be properly adjusted by taking a network environment or other parameters into consideration. If all the conditions (α), (β) and (γ) are satisfied, the start byte of the packet currently assumed is recognized as the byte of an actual packet. If any one of the conditions (α), (β) and (γ) is not satisfied, a next byte is assumed to be the start point of the packet, and a relevant data block is searched for the start point of a first packet by repeatedly performing the condition verification processes (α), (β), and (γ).

In FIG. 5, all the conditions (α), (β), and (γ) are used to verify the start point of the packet, but this is only an example. For example, the start point of the packet may be verified based on only one or two of the (α), (β), and (γ) conditions, or the start point of the packet may be verified using additional information to the above conditions. With an increase in the number of conditions used for verification, the start point of the packet may be verified more accurately.

If movement is made to the start point of the first packet in the data block according to the method shown in FIG. 5, the start point of the first packet is defined as the start point of an InputSplit. That is, the InputSplit of the data block defines a range from the start point of the first packet to before the start point of an InputSplit for a next data block as the InputSplit for a corresponding data block.

After the InputSplit is defined, in order to perform a Map task of the defined InputSplit, the RecordReader for reading CapLen, recorded on the pcap header, from the start point of the InputSplit and reading packets by the CapLen is created and returned to the Mapper. In this case, a pair of (Key, Value) transferred from the RecordReader to the Mapper have a (LongWritable, BytesWritable) Writable class type of Hadoop. An offset from the start point of a file may be used as the Key. A packet corresponding to a specific protocol on the OSI 7 layer, such as an Ethernet frame, an IP packet, a TCP segment, an UDP segment, and http payload corresponding to all the bytes of a packet record, may be extracted and transferred as the Value. Likewise, a packet from which a pcap header has not been removed (that is, all bytes including the pcap header and the Ethernet frame) may be used as the Value. Furthermore, a packet corresponding to all protocols on the OSI 7 Layer, such as ICMP, ARP, RIP, and SSL, may be used as the Value, but not limited thereto. It will be evident to those skilled in the art that the Value is properly selected according to data to be analyzed.

After the specific InputSplit using the start point of the first packet in the block as the boundary of the specific InputSplit and a previous InputSplit is defined as described above and the RecordReader is then returned, the Mapper performs the Map function of reading records from the InputSplit one by one using the RecordReader. Here, the RecordReader checks whether an offset of the start point of a record to be transferred exceeds the area of a data block to be processed in order to determine whether all the records of the InputSplit for the data block have been processed so that the offset does not invade the area of InputSplits of a subsequent block. If the offset does not invade the area of the InputSplits of the subsequent block, the RecordReader repeatedly performs the process of reading and generating records until the offset invades the area of the InputSplits of the subsequent block. If the last packet is split and stored in a next block, packet records are completed by reading some of the next blocks and the packet records are then returned.

In the packet analysis of the present invention, the process for analyzing and processing packet data may be performed using a single process, but may include second and third processes for performing additional analysis using an analysis result of the previous job. That is, the packet analysis method of the present invention may further include the step (E) of performing a second process for extracting the records stored in the HDFS at step (D), analyzing record data by performing MapReduce processing for the extracted records, and storing the analysis result in the HDFS. It is evident that such packet analysis may be performed using third and fourth processes for analyzing a result of the second process in more detail.

Here, assuming that the result of the first process including steps (A) to (D) is stored in the HDFS in a binary data format having records of a fixed length at step (D), the extraction of the records at step (E) may be performed using the input format, including the steps of (a) receiving the length of records of the binary data; (b) defining a specific InputSplit by setting the boundary of the specific InputSplit and a previous InputSplit based on a value closest to the start point of a data block to be processed, from among points which are an n multiple of the length of records in the data block, from among the data blocks stored in the HDFS, as the start point; (c) creating a RecordReader for performing a job for reading the entire area of the defined InputSplit from the start point by the length of the records and for returning the RecordReader; and (d) extracting records, each having a pair of (Key, Value) in a (LongWritable, BytesWritable) form, through the RecordReader. The input format for analyzing the binary data of a fixed length is also called a binary input format.

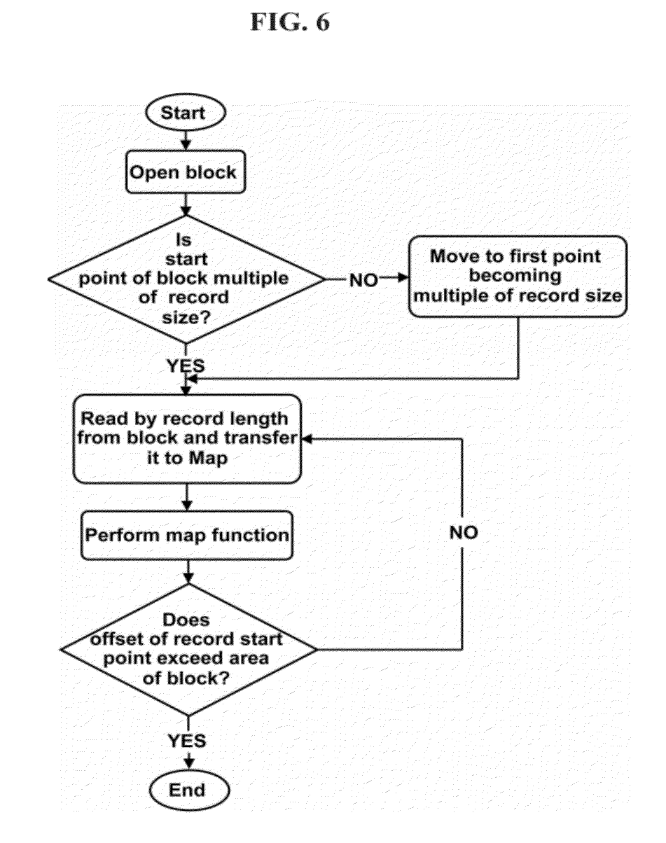

FIG. 6 is a flowchart illustrating a procedure of the cluster of nodes of Hadoop reading and processing data blocks in order to perform the MapReduce process using the binary input format according to the present invention.

First, the length of a record of binary data is received through a module hereinafter referred to as “JobClient.” In the method of receiving the value, information about the size of the record may be allocated to a specific property using Configuration Property, and all the nodes in the cluster may share the specific property. In an alternative embodiment, the information about the size of the record may be allocated to a specific file/data container using DistributedCache, and all the nodes in the cluster may share the file accordingly. When a data block is opened for data processing, a check is conducted as to whether the start point of the data block is a point which is an n multiple of the length of the record, wherein n is 0 or a natural number. If, as a result of the check, the start point of the data block is the point which is an n multiple of the length of the record, the corresponding point is defined as the start point of an InputSplit. If, as a result of the check, the start point of the data block is not the point which is an n multiple of the length of the record, the process of checking whether the start point of the data block is the point which is an n multiple of the length of the record is performed while moving by 1 byte. The first point that is an n multiple of the length of the record through the above process is defined as the start point of the InputSplit. In other words, the range from a value closest to the start point of the data block, from among points which are an n multiple of the record length, to before the start point of an InputSplit for a next data block is defined as the InputSplit of the data block.

After the InputSplit is defined, in order to perform the Map job from the InputSplit, the RecordReader for performing a process of extracting records by reading the records based on the length of the record from when the start point of the InputSplit is created and then returned. In this case, a pair of (Key, Value) transferred from the RecordReader to the Map have a (LongWritable, BytesWritable) writable class type of Hadoop. For example, the records may be extracted in the form of an offset value from a file start point and record data and then sent to the Map.

For example, flow data of NetFlow v5 is described. NetFlow v5 packet data can be written as the Value. That is, the Value may be a value in which one or more packets selected from a group consisting of the number of packets, the number of bytes, and the number of flows are configured in one byte arrangement.

A value, having a different meaning as the index of a record other than the offset value, may be defined as the Key according to data to be processed and the property of a process. In NetFlow analysis, if it is sought to find the total number of packets, the total number of bytes, and the total number of flows for every port number, not an offset value from a file, but the port number may be used as the Key. If the total number of packets, the total number of bytes, and the total number of flows according to a source IP is desired, the source IP may be defined as the Key. If the total number of packets, the total number of bytes, and the total number of flows for every port number at specific time intervals is desired, the timestamp of a flow and a port number may be configured in one byte arrangement and then transferred as the Key, If an analysis of flow data for every source IP at specific time intervals is desired, all combinations for all items constituting a packet may be configured as the Key, as in the method of configuring the timestamp of a flow and a port number in one byte arrangement, transferring it as the Key, and then analyzing it using the MapReduce program. As described above, either an offset value from a file, a value in which a source port number, a destination port number, a source IP address, a destination IP address, the timestamp of a flow, or a source port number may be configured in a one byte arrangement, a value in which the timestamp of a flow and a destination port number are configured in a one byte arrangement, a value in which the timestamp of a flow and a source IP address are configured in a one byte arrangement, and a value in which the timestamp of a flow and a source or destination IP address are configured in a one byte arrangement may be used as the Key.

After the InputSplit using the first start point of the record from the data block as the boundary of the InputSplit and a previous InputSplit is defined as described above and the RecordReader is returned, the Mapper performs the Map Function of reading records from the InputSplit one by one using the RecordReader. Here, in order to determine whether all the records of the InputSplit have been processed, the RecordReader checks whether an offset of the start point of the records extracted from the InputSplit exceeds the area of the data block to be processed so that the offset does not exceed the area of the InputSplit of a subsequent block. If, as a result of the check, the offset does exceed the area of the InputSplit of the subsequent block, the RecordReader repeatedly performs the process of reading and generating records until the offset exceeds the area of the InputSplit of the subsequent block.

When flow analysis is performed by the Hadoop Mapper & Reducer using the BinaryInputFormat, the flow is read from the HDFS in units of blocks, record of a binary format are extracted from the data block using the BinaryInputFormat, and the extracted records are sent to the Mapper. The transferred records are subjected to the MapReduce processing, and the processing result can be outputted in a binary format and stored in the HDFS. The output of the binary format may be simply implemented by extending a FileOutputFormat (that is, a class for the output of a file to the HDFS) also called BinaryOutputFormat. Both the Key and the Value of the output record (that is, BytesWritable) are included in the binary data of the BytesWritable form as the analysis result of the MapReduce processing and then outputted to the HDFS.

If the pcap input format or the binary input format is used, an InputSplit can be defined for a data block of a binary format stored in each distribution node, thereby enabling simultaneous access and processing. Since the binary packet data is extracted from the InputSplit and sent to the Mapper, processing can be performed without the existing conversion job into other data formats, smaller storage space than space for other formats is required, and thus the processing speed can be increased.

In the data analysis at step (C), the analysis result can be obtained by a pair of proper (Key, Value) according to characteristic to be analyzed and then performing the MapReduce program. For example, the step of, 1) if it is sought to find statistics by generating a flow from a packet, finding statistics of the number of bytes and packets of a flow for every time zone and the number of flows based on information on which the timestamps of the packets are classified into areas on the basis of a 5-tuple (that is, a source IP, a destination IP, a source port number, a destination IP number, and a protocol) and a flow duration, 2) finding statistics of total bytes and packets for every IP version and protocol for the packets and the number of flows and finding statistics, such as the number of unique IPs or ports for every unique protocol version, or 3) if it is sought to find a traffic volume for every port and for every IP, finding the number of bytes, the number of packets, and the number of flows based on each port or IP and a protocol and finding the number of bytes, the number of packets, and the number of flows of a packet for every time zone may be performed.

For this purpose, in the MapReduce analysis process at step (C), as described above, one or more jobs for performing analysis by extracting records from the HDFS using the Mapper & Reducer may be performed. For example, the process of reading binary packet data, generating a flow as an intermediate processing result by classifying the binary packet data into a 5-tuple, storing the file in the HDFS in the binary data format having records of a fixed length, reading the binary flow data, and analyzing the flow may be performed. The description of the above-described analysis items is only illustrative, and therefore, a variety of methods are possible according to the subject of analysis.

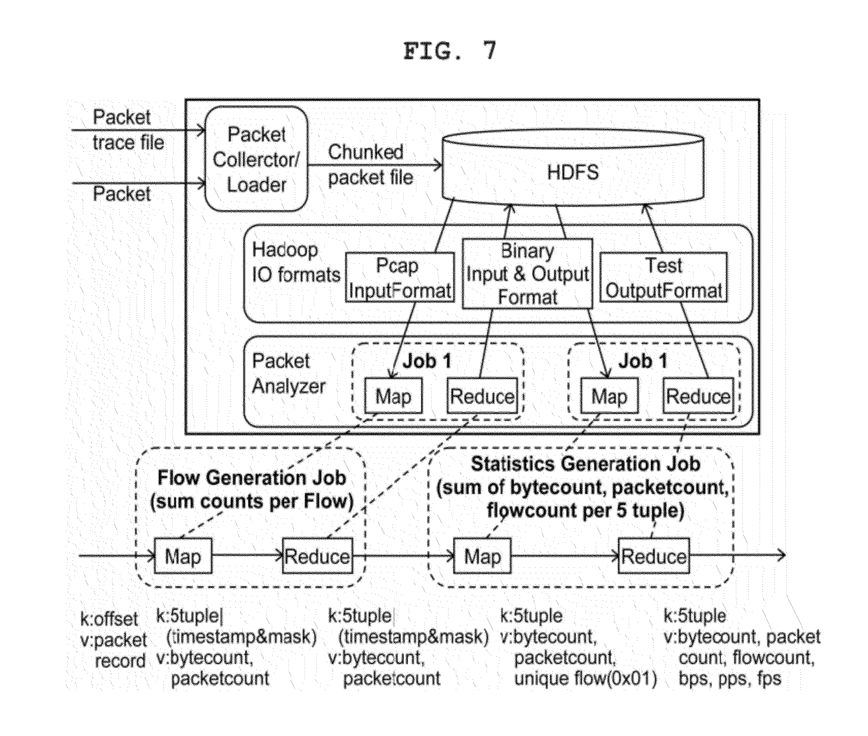

FIGS. 7 to 10 show more detailed packet analysis processes according to an embodiment of the present invention.

FIG. 7 shows an exemplary process of analyzing packets using the MapReduce method and shows a process of finding the total number of bytes, the total number of packets, and the total number of flows for every time zone by extracting flows from packets in association with the system module of the present invention. The present packet analysis process includes a total of at least two MapReduce processes. In the first process, a flow is generated from packets by configuring a Map function to extract the contents of the packet by using a value in which 5-tuple and the capture time of a packet from individual packet records are masked into a certain time zone as a key and a Reduce function for adding the number of bytes and the number of packets for the key.

In the second process, i.e., the Map function for reading a generated flow record, 5-tuple from which a capture time masked from the key value is detached as a key, and configuring “1” indicating the number of flows, together with the number of bytes and the number of packets, as a value in order to find the number of flows and a Reduce function for fetching the value and adding the total number of bytes, the number of packets, and the number of flows for every 5-tuple are configured, and final statistics for every flow are outputted.

The statistics for every flow using a packet are only an example of the parallel packet processing, and the process may be performed by implementing the Map and Reduce functions according to the subject of analysis. Furthermore, a more complicated and refined analysis result may be obtained by configuring one or more processes and connecting a result of a previous process to the input of a next process.

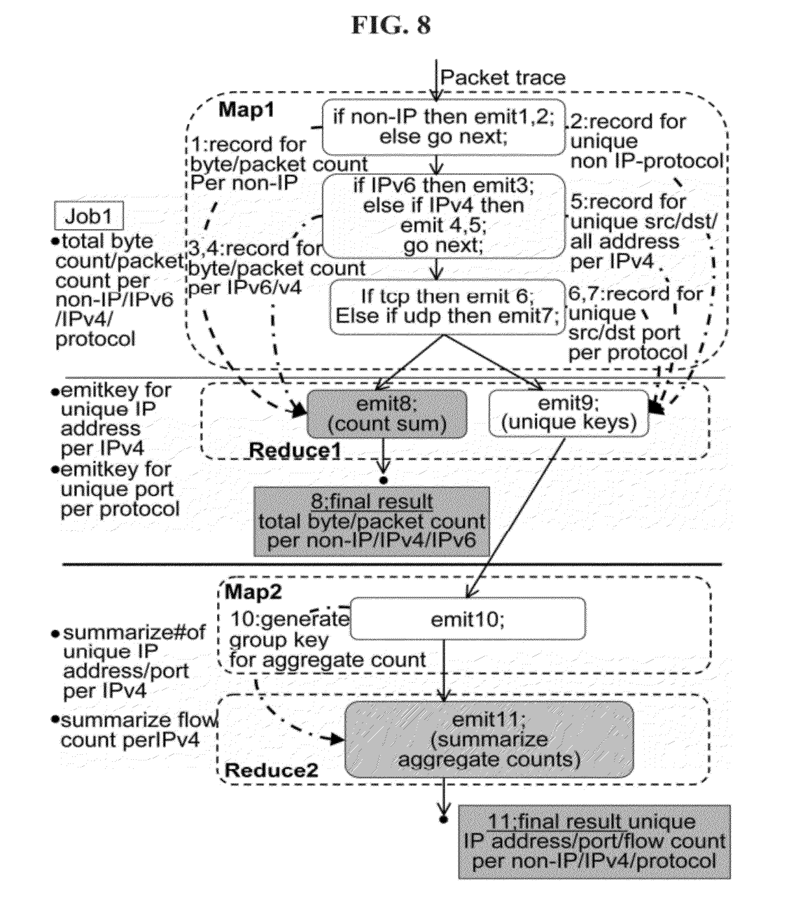

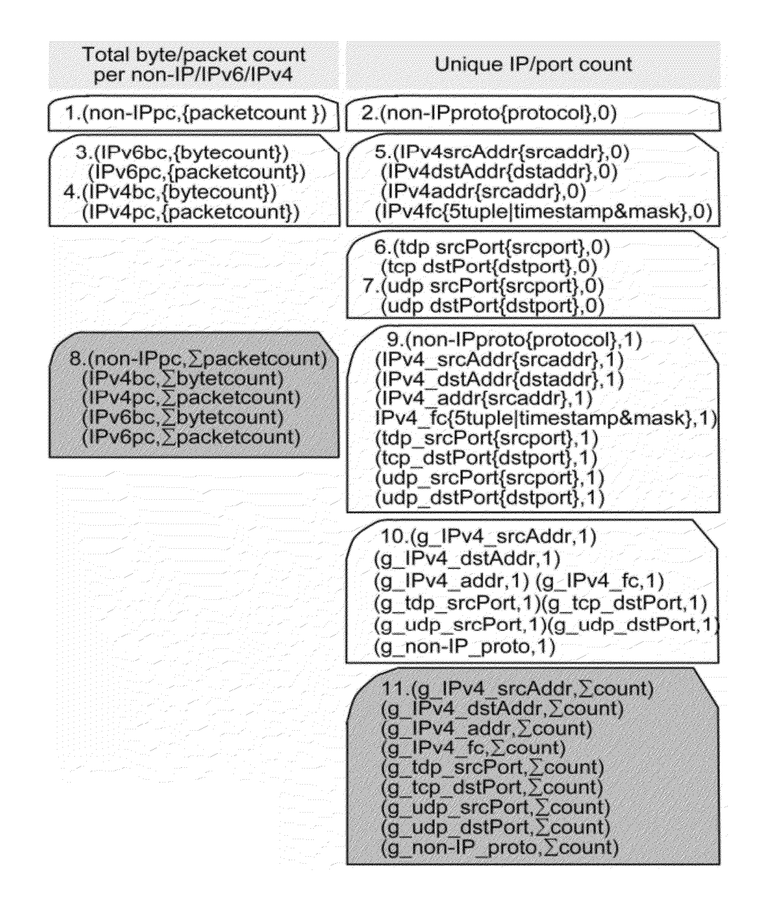

FIG. 8 shows an algorithm implemented by configuring two MapReduce processes in order to find the number of bytes, the number of packets for every IP version, the number of unique source and destination IP addresses, and the number of unique port numbers for every protocol, and the number of flows for, e.g., IPv4 in relation to the total amount of traffic. In the first process, the number of bytes and the number of packets are found, e.g., by distinguishing Non-IP, IPv4, and IPv6, and the key and unique value 1 of each record are generated in order to find an IP address for every source and destination of the unique IPv4, and a port number for every protocol. Furthermore, in order to find the number of flows for IPv4, a value in which 5-tuple and the capture time of a packet are masked from packet records according to a certain time zone is found as a key. In the second job, in order to find statistics having a unique value on the basis of a key indicating a specific record value, a group key for a calculation item is generated and sent to the Reducer, so the sum for the same group is found.

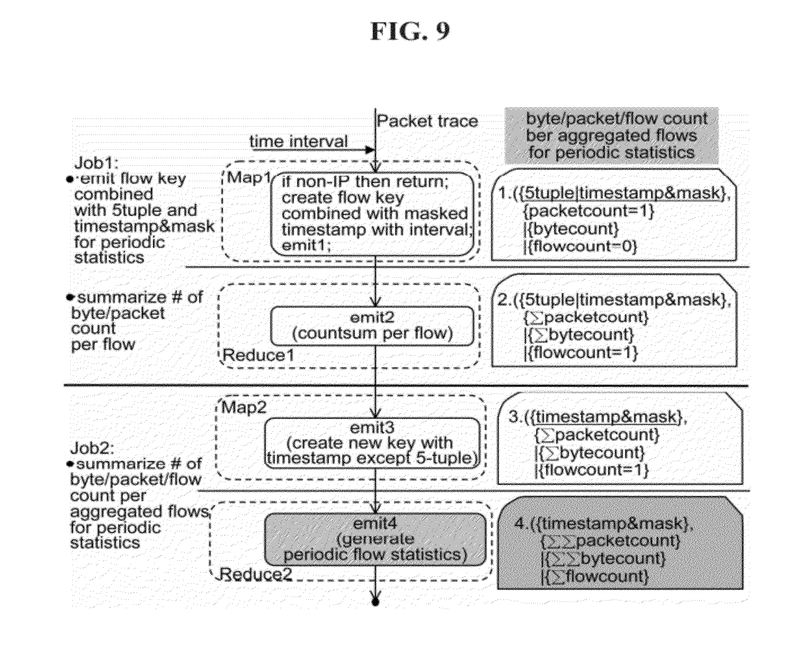

FIG. 9 shows an algorithm for finding statistics of flows shown in FIG. 7. A description of a job is the same as described in FIG. 7.

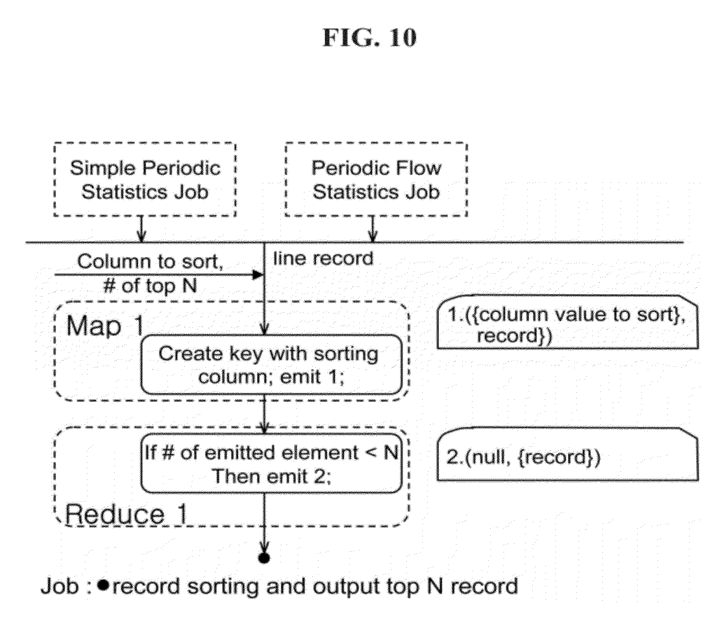

FIG. 10 shows an algorithm for aligning results obtained in a previous job and outputting only an n number of records having the highest value or the lowest value. In the Map process, results of a previous process are received and a reference to be aligned is generated as a key. In the Reduce process, only an n number of results, from among the results aligned as the key, are extracted and outputted.

As described above, in accordance with the packet analysis system and method according to the present invention, a large quantity of packet traces can be rapidly processed because packet data is stored and analyzed in a Hadoop cluster environment.

Furthermore, in accordance with the input formats according to the present invention, when binary data having records of a fixed length and binary packet data having records of a variable length, such as NetFlow v5, are distributed and processed in a Hadoop environment, an InputSplit for each distribution node is defined, enabling simultaneous access and processing. Furthermore, since binary packet data is extracted from an InputSplit and sent to the Mapper, processing can be performed without a conversion process into other data formats. Accordingly, smaller storage space than data of other formats is required and the processing speed can be increased.

The data analysis method of a binary form according to the present invention may be used in the construction of an invasion detection system through various applications, such as pattern matching of packets using a Hadoop system, and in the field of analysis dealing with binary data, such as image data, genetic information, and encryption processing. Furthermore, advantageously, there are cost advantages to the present invention in that costs can be reduced because a plurality of servers performs packet analysis through parallel computation and a high-performance and expensive server is not required.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A packet analysis system based on a Hadoop framework, comprising:
a packet collection module for distributing and storing packet traces in a Hadoop Distributed File System (HDFS);
a Mapper & Reducer for distributing and processing the packet traces stored in the HDFS in cluster nodes of Hadoop using a MapReduce method; and
a Hadoop input/output format module for transferring the packet traces of the HDFS to the Mapper & Reducer so that the packet traces are processed according to the MapReduce method and outputting results, analyzed by the Mapper & Reducer using the MapReduce method, to the HDFS.

2. The packet analysis system as claimed in claim 1, wherein the packet collection module comprises:
a packet collection unit for collecting the packet traces from packets over a network; and
a packet storage unit for storing the packet traces, collected by the packet collection unit, or a previously generated packet trace file in the HDFS using a Hadoop file system API.

3. A packet analysis method using Hadoop-based parallel computation, comprising the steps of:
(A) storing packet traces in an HDFS;
(B) cluster nodes of Hadoop reading the packet traces stored in the HDFS, extracting records from the packet traces, and transferring the records to MapReduce composed of a Mapper and a Reducer;
(C) analyzing the transferred records using a MapReduce method; and
(D) storing the analyzed records in the HDFS.

4. The packet analysis method as claimed in claim 3, wherein the packet traces at step (A) are collected from packets traces generated in a packet trace file form or are captured from packets collected in real time over a network.

5. The packet analysis method as claimed in claim 3, wherein the step (B) is performed using an input format comprising the steps of:
(a) obtaining information about a start time and an end time when packets are captured, from a file shared by a configuration property or a DistributedCache;
(b) searching for a start point of a first packet in a data block to be processed, from among data blocks stored in the HDFS;
(c) defining a specific InputSplit by setting a boundary of the specific InputSplit and a previous InputSplit by using the start point of the first packet as a start point of the specific InputSplit;
(d) generating a RecordReader for performing a job for reading an entire area of the defined InputSplit from the start point of the defined InputSplit by a capture length, recorded on a captured pcap header of each packet, and for returning the generated RecordReader; and
(e) extracting the records, each having a pair of (Key, Value) in a (LongWritable, BytesWritable) form, using the generated RecordReader.

6. The packet analysis method as claimed in claim 5, wherein, assuming that the start byte of the data block is a start point of the first packet, the start point of the first packet is searched for by repeating the steps of:
(i) extracting header information, comprising a timestamp, a capture length CapLen, and a wired length WiredLen, from the pcap header of the packet at a point assumed to be the start point of the first packet;
(ii) moving as much as (the length of the pcap header+the CapLen), obtained at step (i), from a point assumed to be the start byte of the first packet;
(iii) assuming that the point moved at step (ii) is a point start of a second packet, extracting header information, comprising a timestamp, a capture length CapLen, and a wired length WiredLen, from the pcap header; and
(iv) verifying whether the point assumed to be the start point of the first packet is identical to the start point of the first packet based on the pieces of pcap header information about the first and second packets obtained at steps (i) and (iii);
(v) if, as a result of the verification at step (iv), the point assumed to be the start point of the first packet is not the start point of the first packet, repeating the steps (a) to (d) assuming that a point moved by 1 byte from the point assumed to be the start point of the first packet is the start point of the first packet.

7. The packet analysis method as claimed in claim 6, wherein the step (iv) includes the step of defining that the point assumed to be the start point of the first packet is the start point of the first packet, if each of the timestamp of the first packet and the timestamp of the second packet obtained at steps (i) and (iii) is a valid value within a range from a capture start time of a packet obtained from a common file according to the configuration property or the DistributedCache at step (a) to a capture end time of the packet, (a difference between the WiredLen and the CapLen) of the first packet obtained at step (i) is smaller than (a difference between a maximum packet length and a minimum packet length), and (a difference between the WiredLen and the CapLen) of the second packet obtained at step (iii) is smaller than (a difference between a maximum packet length and a minimum packet length).

8. The packet analysis method as claimed in claim 7, wherein the step (d) includes the step of further checking whether a difference between the timestamp of the first packet and the timestamp of the second packet obtained at steps (a) and (c) falls within a range of a delta time in which packets are recognized to be continuous.

9. The method as claimed in claim 5, further comprising the step (E) of performing a second job for extracting the records stored in the HDFS at step (D), analyzing record data by performing MapReduce processing for the extracted records, and storing the analysis result in the HDFS.

10. The packet analysis method as claimed in claim 9, wherein:
at step (D), the records are stored in a binary data form having records of a fixed length, and
the extraction of the records at step (E) is performed using an input format, comprising the steps of:
(a) receiving a length of the records of the binary data;
(b) defining a specific InputSplit by setting a boundary of the specific InputSplit and a previous InputSplit by using a value closest to a start point of a data block, from among points which are an n multiple of a length of records in a data block to be processed, from among the data blocks stored in the HDFS, as a start point;
(c) creating a RecordReader for performing a job for reading an entire area of the defined InputSplit from the start point by the length of the records and for returning the RecordReader; and
(d) extracting records, each having a pair of (Key, Value) in a (LongWritable, BytesWritable) form, through the RecordReader.

11. A packet analysis system for a distributed file system, comprising:
a first module for distributing and storing packet traces in the distributed file system;
a second module for distributing and processing the packet traces stored in the distributed file system in a cluster of nodes; and
a third module for transferring the packet traces of the distributed file system to the second module so that the packet traces are processed according to a process for distributing and processing input data and outputting results to the distributed file system, the results analyzed by the second module using the process for distributing and processing input data.
